(19) United States
(12) Patent Application Publication
(10) Pub. No.: US 2015/0007079 A1
(43) Pub. Date: Jan. 1, 2015

(54) COMBINING PARALLEL COORDINATES AND HISTOGRAMS

(71) Applicant: Silicon Graphics International Corp., Fremont, CA (US)

(72) Inventor: Marc David Hansen, Morgan Hill, CA (US)

(21) Appl. No.: 13/931,785

(22) Filed: Jun. 28, 2013

(51) Int. Cl. G06F 3/0484

(52) U.S. Cl. CPC G06F 3/0484
USPC 715/771

(57) ABSTRACT

A system provides data visualization with the capability of combining parallel coordinates and histograms. Parallel coordinates typically display lines between two or more vertical lines representing a coordinate element. In addition to displaying lines between coordinate element axes, histograms are provided at each element line to indicate the instances of data associated with line values. To create parallel coordinates with histograms, bin values may be determined for the parallel coordinates. Data is then accessed, and a particular bin value is incremented for each data point that falls within the bin. The parallel coordinates are then displayed with the histograms indicating a quantity of data associated with each coordinate value.

### BACKGROUND

1. Field of the Invention

The present invention relates to visualization of data. In particular, the present invention relates to three dimensional data visualization.

2. Description of the Prior Art

Visualization of data in three dimensional graphs can be helpful to understand the data. An example of a three dimensional graph is a plot of data on multiple axis, such as a horizontal, vertical, and another coming towards or away from the point of view of a viewer. Three dimensional coordinate graphics are sometimes translated into parallel coordinates. This can be helpful to identify data values in another format, but can quickly become overwhelming with a large number of data points

With big data applications becoming increasingly popular, there is a need to display large amounts of data in multiple formats in order to better understand the relationships of the data. What is needed is an improved visualization interface for displaying data as desired by a user.

### SUMMARY

The present technology may provide data visualization with the capability of combining parallel coordinates and histograms. Parallel coordinates typically display lines between two or more vertical lines representing a coordinate element. Rather than displaying only lines between coordinate element lines, histograms are also provided at each element line to indicate the instances of data associated with line values. To create parallel coordinates with histograms, bin values may be determined for the parallel coordinates. Data is then accessed, and a particular bin value is incremented for each data point that falls within the bin. The parallel coordinates are then displayed with the histograms indicating a quantity of data associated with each coordinate value.

An embodiment may perform a method for displaying data. An image of parallel coordinates may be provided. The image may correspond to a set of multi-dimensional data through an interface provided on a display. A plurality of histograms may be provided on each of the axes forming the visual representation of the parallel coordinates. The histograms may be determined from the set of multi-dimensional data.

An embodiment may include a system for displaying data. The system may include a processor, a memory, and one or more modules stored in memory. The one or more modules may be executed by the processor to provide an image of parallel coordinates corresponding to a set of multi-dimensional data through an interface provided on a display and provide a plurality of histograms on each parallel coordinate, the histograms determined from the set of multi-dimensional data.

### BRIEF DESCRIPTION OF THE DRAWINGS

FIG. 1 is a system for processing and visualizing data.

FIG. 2 is a method for processing and visualization data.

FIG. 3 is a method for providing a parallel coordinates with histograms.

FIG. 4 illustrates data points in three dimensional x,y,z coordinate system.

FIG. 5 is illustrates data points in parallel coordinates.

FIG. 6 illustrates data points in parallel coordinates with histograms.

FIG. 7 provides a computing device for implementing the present technology.

### DETAILED DESCRIPTION

The present technology may provide data visualization with the capability of combining parallel coordinates and histograms. Parallel coordinates typically display lines between two or more vertical lines representing a coordinate element. Rather than displaying lines between coordinate element lines, histograms are provided at each element line to indicate the instances of data associated with line values. To create parallel coordinates with histograms, bin values may be determined for the parallel coordinates. Data is then accessed, and a particular bin value is incremented for each data point that falls within the bin. The parallel coordinates are then displayed with the histograms indicating a quantity of data associated with each coordinate value.

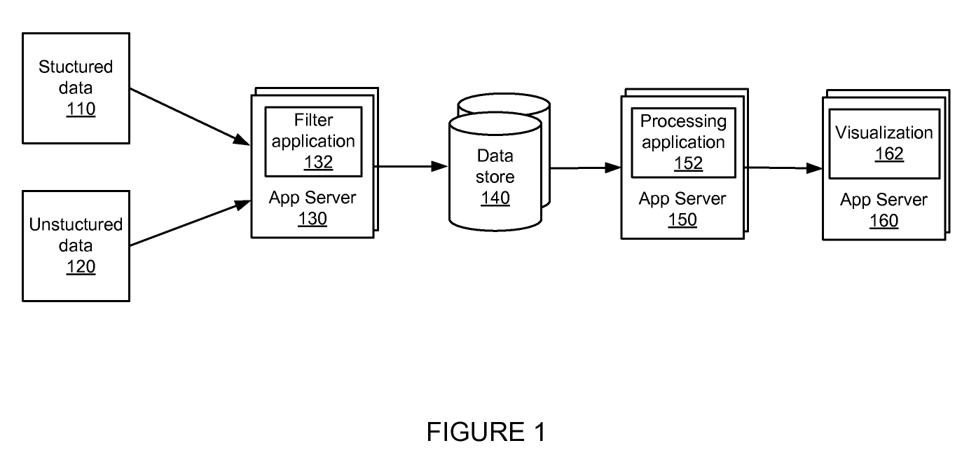

FIG. 1 is a system for processing and visualizing data. The system of FIG. 1 includes structured data 110, unstructured data 120, application servers 130, 150 and 160, and data store 140. Structured data 110 (RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server may include one or more servers which receive and access structured data 110 and unstructured data 120. Filter application 132 may be stored and executed on application server 130, and may be executed to ingest and the structured and unstructured data. Filter application 132 may apply filters, intelligence, or other processes to select a subset of the data received and/or accessed.

Data store 140 may include one or more data stores which receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application which provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

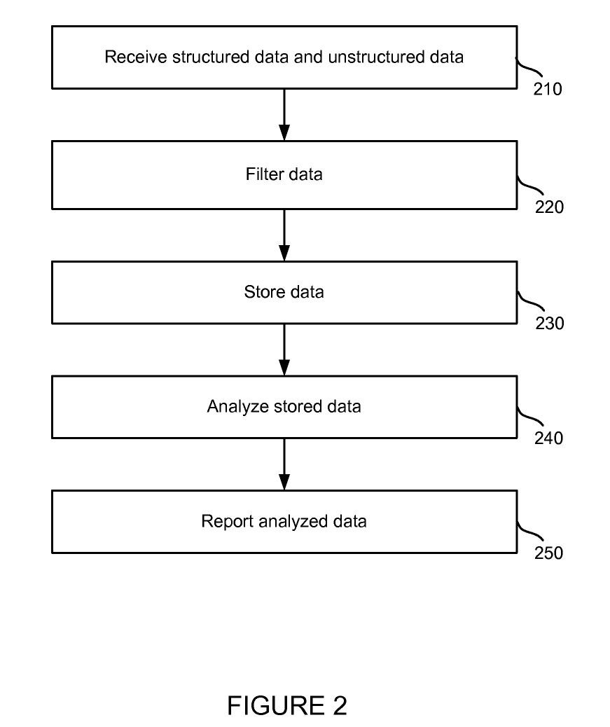

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

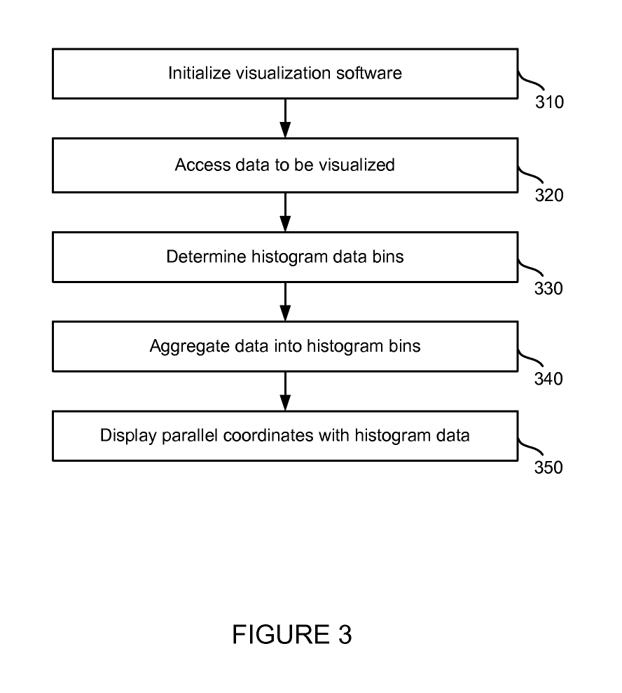

Filtered data may be stored at step 230. The data may be stored based on the type of data it is. For example, structured data may be stored in a SQL database and unstructured data may be stored in a NoSQL database. The stored data may be analyzed at step 240. Analyzing the data may include looking for trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a three dimensional graph of data and provide data in a parallel coordinates with histograms. Step 250 is discussed in more detail with respect to FIG. 3.

FIG. 3 is a method for providing a visualization of data. The method of FIG. 3 may provide more detail for step 250 of the method of FIG. 2. In embodiments, visualization application 162 may perform the steps of FIG. 3. The visualization application 162 may extract stored data, mine data for desired information, and provide an interactive visualization of the data.

First, visualization software is initialized at step 310. Initializing the data may include executing the software, identifying what data to retrieve, and other configurations of the software. Data to be visualized may be accessed at step 320. The data may be accessed locally or remotely, for example from data store 140.

Histogram bins may be determined at step 330. Each histogram bin may be associated with a range of data. Data points will be placed in a particular histogram bin if the data point value is within a particular bin's range. The number of bins may depend on the value ranges of the data to be visualized, the desired detail to convey in the visualization, user preference, and other factors. Once the number of bins is selected, the bin ranges may be selected by dividing the axis length by the number of bins. For example, if an axis was to cover data values ranging from 0 to 1000 units on a screen, and there were 20 bins to display on the axis, each bin would have a range of 50 units. Bins may also have different ranges, if desired. For example, one or more bins may have a larger range or narrower range based on the frequency of data values, weighting of bins, and other factors.

After histogram data bins are determined, data is aggregated into the histogram bins at step 340. The values from every data point are used to populate the appropriate bin. For example, if a data point had values of [4, 14, 21], and bins for each parallel coordinate had ranges of 0-9, 10-19, and 20-29, the [0-9] bin count would be incremented for the first coordinate from the [4] value, the [10-19] bin count would be incremented for the second coordinate from the [14] value, and the [20-29] bin count would be incremented for the third coordinate from the [21] value.

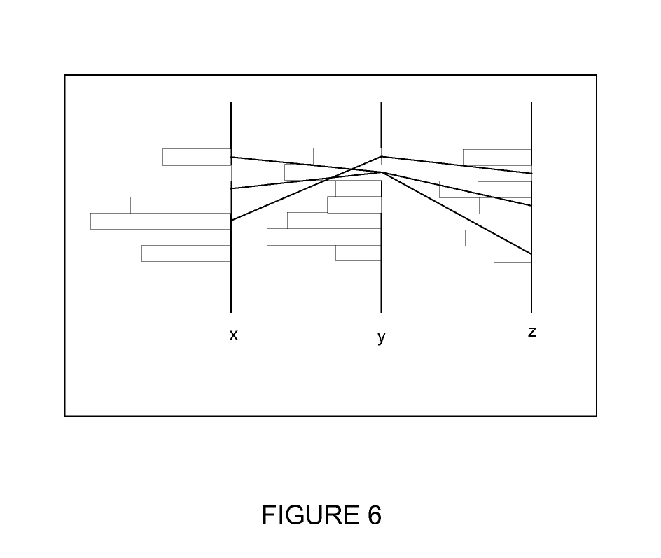

After aggregating the data into the histogram bins, the parallel coordinates with histogram data would be displayed at step 350. An example of a parallel coordinate with histograms is displayed in FIG. 6.

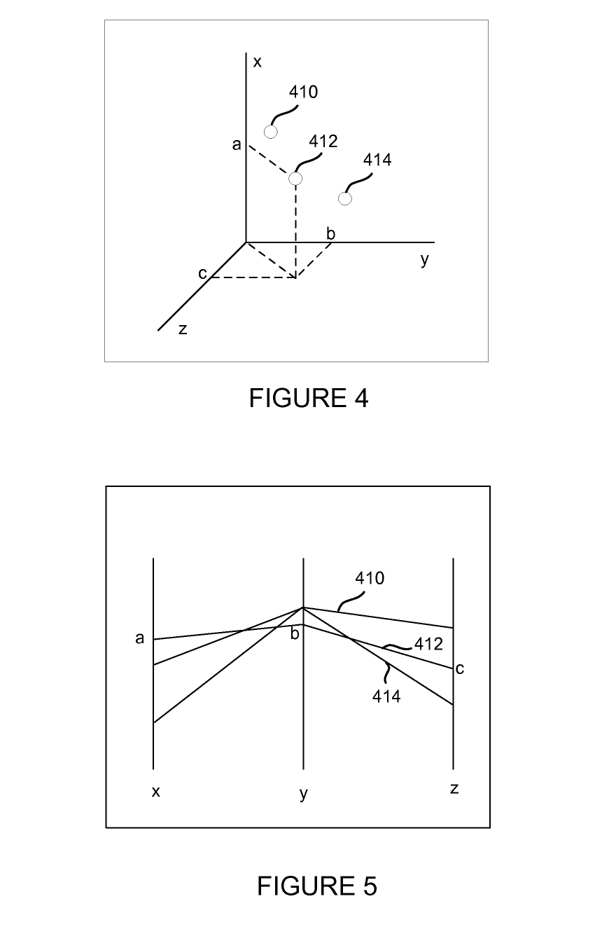

FIGS. 4-6 illustrate examples of a visualization interface for displaying three dimensional data. FIG. 4 illustrates data points in three dimensional x,y,z coordinate system. The interface of FIG. 4 displays an x,y,z graphical coordinate system with data points 410, 412 and 414. Each data point has a value corresponding to each of the x axis, y axis and z axis. For example, data point 412 has an x value of a, a y value of b, and z value of c.

FIG. 5 illustrates data points in parallel coordinates. The parallel coordinates display each data point in the x,y,z coordinate system of FIG. 4 as a set of lines between the three parallel coordinates labeled x, y and z. For example, data point 412 is displayed in the parallel coordinates as having a value of a on the x coordinate, a value of b on the y coordinate, and a value of c on the z coordinate. The parallel coordinates provide a line between the values on the different parallel axes for a data point. For example, there is a line connecting point a on the x axis and point b on the y axis as well as a line between point b on the y axis and point c on the z axis.

FIG. 6 illustrates data points in parallel coordinates with histograms. As shown in FIG. 6, each parallel coordinate includes a plurality of histograms that indicate the data value frequency for a particular bin. The histograms may include graphics which increase in size as the data for the corresponding bin increases. The histograms may also include numerical information for providing a numerical value for the bin, in addition to the graphical representation of the bin size. In addition to the histogram on each axis in the parallel coordinate image, lines may be included to map out coordinates between the axes. Three lines are shown for exemplary purposes.

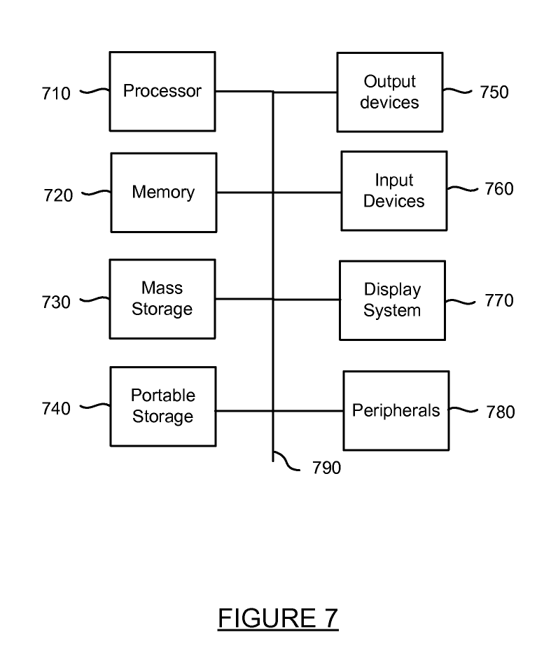

FIG. 7 provides a computing device for implementing the present technology. Computing device 700 may be used to implement devices such as for example application servers 130, 150 and 160 and data stores 140. FIG. 7 illustrates an exemplary computing system 700 that may be used to implement the present technology. System 700 of FIG. 7 may be implemented in the contexts of the likes of client computer 210, servers that comprise services 230-250 and 270-280, application server 260, and data store 267. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for displaying data, comprising:
providing an image of parallel coordinates corresponding to a set of multi-dimensional data through an interface provided on a display; and
providing a plurality of histograms on each parallel coordinate, the histograms determined from the set of multi-dimensional data.

2. The method of claim 1, further comprising determining a data range for a histogram data bin.

3. The method of claim 1, further comprising aggregating the data bins from the set of multi-dimensional data.

4. The method of claim 1, wherein the histograms include graphical information and numerical information.

5. The method of claim 1, wherein the data bins include at least two data bins having data ranges which differ in length.

6. A computer readable storage medium having embodied thereon a program, the program being executable by a processor to perform a method for displaying data, the method comprising:
providing an image of parallel coordinates corresponding to a set of multi-dimensional data through an interface provided on a display; and
providing a plurality of histograms on each parallel coordinate, the histograms determined from the set of multi-dimensional data.

7. The computer readable storage medium of claim 6, the method further comprising determining a data range for a histogram data bin.

8. The computer readable storage medium of claim 6, the method further comprising aggregating the data bins from the set of multi-dimensional data.

9. The computer readable storage medium of claim 6, wherein the histograms include graphical information and numerical information.

10. The computer readable storage medium of claim 6, wherein the data bins include at least two data bins having data ranges which differ in length.

11. A system for displaying data, comprising:
a processor;
memory;
one or more modules stored in memory and executed by the processor to provide an image of parallel coordinates corresponding to a set of multi-dimensional data through an interface provided on a display and provide a plurality of histograms on each parallel coordinate, the histograms determined from the set of multi-dimensional data.

12. The system of claim 11, the one or more modules executable to determine a data range for a histogram data bin.

13. The system of claim 1, the one or more modules executable to aggregate the data bins from the set of multi-dimensional data.

14. The system of claim 11, wherein the histograms include graphical information and numerical information.

15. The system of claim 11, wherein the data bins include at least two data bins having data ranges which differ in length.
